(19) United States
(12) Patent Application Publication
(10) Pub. No.: US 2013/0283526 A1
(43) Pub. Date: Oct. 31, 2013

(54) THERAPEUTICBED FOR PREGNANT, OBESE AND/OR SPECIAL NEEDS PATIENTS OR PATRONS

(71) Applicant: Nella Gagliardi, Rutherford, NJ (US)

(72) Inventor: Nella Gagliardi, Rutherford, NJ (US)

(21) Appl. No.: 13/459,194

(22) Filed: Apr. 29, 2012

(51) Int. Cl. A61G 7/05; A47C 21/04; A47C 27/10

(52) U.S. Cl. 5/421; 5/618; 5/655.3

(57) ABSTRACT

A therapeutic bed or treatment table capable of being employed for a massage or rendering chiropractic, medical, therapeutic, or other treatment to a patient or customer includes an upper torso support cushion having a plurality of breast recesses configured for accommodating human breasts; and an abdominal support cushion having an abdominal recess configured for accommodating a mid-section of an obese person or pregnant woman, wherein the plurality of recesses is configured to provide an adjustable support structure adaptive to the size of the human breasts and/or the mid-section of an obese person or pregnant woman. In an alternative embodiment, an unitary torso-abdominal support cushion is provided having a recess configured for accommodating human breasts and accommodating the mid-section of an obese person or pregnant woman.

### TECHNICAL FIELD

The exemplary and non-limiting embodiments of this invention relate generally to an apparatus, system and method for performing a massage or rendering chiropractic, medical, therapeutic, or other treatment to a patient or customer.

### BACKGROUND

This section is intended to provide a background or context to the exemplary embodiments of the invention. The description herein may include concepts that could be pursued, but are not necessarily ones that have previously conceived, implemented or described. Therefore, unless otherwise indicated herein, what is described in this section is not prior art to the description in this application and is not admitted to be prior art by inclusion in this section.

Currently, there are a limited number of therapeutic treatment tables or beds available for use in rendering chiropractic, medical, therapeutic, or other treatment by chiropractors or masseuses (or other professionals) to women with large breasts, obese patients, pregnant patients, or other special needs patients who have large abdomens or midsections. A typical conventional therapeutic treatment table is shown in U.S. Pat. No. D433,508 entitled “Massage Bench,” and issued to Crowther et al. Crowther discloses a massage bench configured to allow a patron to lie face down on the bench. A single opening is provided for receiving a patron's face and the upper portion of the table is tapered so that the patron's arms can be folded under the table. In addition, the massage bench includes several raised wing portions; one at the upper portion of the table where the patron's head would be placed, as well as a pair of raised wings in the mid-section and another set of raised wings at the bottom section (where the patron's feet would be placed). U.S. Pat. No. 5,946,749 entitled “Comfort Lounge Chair,” and issued to Sewell is another example of a table configured to allow the patron to lie face down, and having an opening for accommodating the face contour. U.S. Pat. Appl. Pub. No. 2010/0037397 entitled “Bed,” and applied for by Wood, discloses a bed for treating sleep apnea. The bed includes multiple separable sections which can be raised or lowered by means of telescopic legs.

Conventional therapeutic treatment tables for woman include U.S. Pat. No. 7,694,370 entitled “Massage Table for Woman,” and issued to Lee, which discloses a massage table configured for the contour of the anatomy of a woman, including a first hole for accommodating the face contour of the woman and a second hole for accommodating the contour of the breasts. Similarly, U.S. Pat. No. 7,636,967 entitled “Massage Table Assembly,” and issued to Stokes, discloses a table top including two circular openings for accommodating a woman's breasts. Another conventional therapeutic treatment table is U.S. Pat. No. D585,139 entitled “Anatomical Portable or Stationary Massage Table” and issued to Andrews, discloses a massage table which includes two openings: one opening for accommodating a woman's breasts and a second opening for accommodating a man's genitals.

U.S. Pat. No. 7,475,439 entitled “Massage Table Apparatus,” and issued to Cox, discloses a massage table with attachments configured for use by a couple in an intimate setting for the mutual satisfaction of both persons engaged in the massage. An alternative configuration allows the masseur to position himself in a kneeling position, or behind and above the receiving person's hips, lower back and torso, in order to provide focused massage to those areas.

U.S. Pat. No. 6,934,988 entitled “Therapeutic Table” and issued to Wetzler et al., discloses a table which includes a rotatable breast recess embedded in pockets of stretchable material to accommodate and support a woman's breasts. Additionally, the table includes an abdominal recess which can accommodate obese or pregnant persons using the table. U.S. Pat. No. 7,020,918 entitled “Cushion Set For Positioning A Human Body” and issued to Tinsley, discloses a collapsible cushion table including a first cushion section having two openings for accommodating a woman's breasts and second and third wedged cushion sections which can crudely accommodate obese persons using the table. U.S. Pat. No. 4,596,384 entitled “Spinal Adjustable Table” and issued to Blosser, discloses a table including a first cushion section for accommodating the patron's face contour, a second cushion section having two openings for accommodating a woman's breasts and a third flat cushion section for accommodating the abdominal section. A fourth section is providing for accommodating the patron's legs. The second and third cushion sections are constructed with a lower spring rate than the first and fourth cushion sections.

There is a need for a therapeutic treatment table or bed which can adjust to provide the proper support and tension customized to the size of the patient, or patron's breasts, or the size of the obese or pregnant patients' abdomen or mid-section.

### SUMMARY OF INVENTION

In accordance with the present invention, there is provided an apparatus comprising an upper torso support cushion having a plurality of breast recesses configured for accommodating human breasts, an abdominal support cushion having an abdominal recess configured for accommodating a mid-section of an obese person or pregnant woman, wherein the plurality of recesses are configured to provide an adjustable support structure adaptive to the size of the human breasts, the mid-section of an obese person or pregnant woman.

In one aspect the plurality of breast recesses further comprise a left and right mesh material coupled to the backing of the upper torso support cushion for providing the adjustable support structure adaptive to the size of the human breasts.

In one embodiment the left and right mesh material are elastic material configured with bands of material stitched and interwoven in rows.

In another aspect the apparatus comprising a left and right tension string circularly interlaced in the left and right mesh material and anchored to the backing of the upper torso support cushion.

In another embodiment the apparatus comprising a left and right push button string clamp configured for attaching to the left and right tension strings adaptable for constricting the left and right mesh material in a convex shape.

In another aspect the plurality of recesses further comprise a left and right donut shaped bladder unit coupled to the backing of the upper torso support cushion for providing the adjustable support structure adaptive to the size of the human breasts.

In one aspect the left and right donut shaped bladder unit further comprise a plurality of sub-unit bladders configured for inflation by air, or hot or cold water, for providing the adjustable support structure adaptive to the size of the human breasts.

In yet another aspect the abdominal recess further comprises an abdominal mesh material coupled to the backing of the abdominal support cushion for providing the adjustable support structure adaptive to the mid-section of an obese person or pregnant woman.

In yet another embodiment the abdominal mesh material is an elastic material configured with bands of material stitched and interwoven in rows.

In yet another aspect apparatus further comprising a plurality of tension strings, each circularly interlaced in the abdominal mesh material and anchored to the backing of the abdominal support cushion, wherein each tension string is interlaced in the abdominal mesh to create successive rings to form a convex shape.

In another embodiment the apparatus further comprising a plurality of push button string clamps configured for attaching to plurality of tension strings adaptable for constricting the abdominal mesh material in a convex shape.

In yet another aspect the abdominal recess further comprises a plurality of donut shaped bladders coupled to the backing of the abdominal support cushion for providing the adjustable support structure adaptive to the mid-section of an obese person or pregnant woman.

In another embodiment the embodiment the donut shaped bladder units further comprise a plurality of sub-unit bladders configured for inflation by air, or hot or cold water, for providing the adjustable support structure adaptive to the mid-section of an obese person or pregnant woman.

In yet another aspect the apparatus further comprising an inflation control mechanism including a controller unit, pump, and regulator for inflating the plurality of sub-unit bladders by means of one or more tubes coupled to each said sub-unit baffle.

In yet another aspect the apparatus further comprising a remote control unit for adjusting the inflation of each said plurality of sub-unit bladders and a heater unit for adjusting the temperature of water supplied to each said plurality of sub-unit bladders.

In another aspect the apparatus further comprising an inflation control mechanism includes a controller unit, pump, and regulator for inflating the plurality of sub-unit bladders by means of one or more tubes coupled to each said sub-unit baffle.

In another aspect the apparatus further comprising an remote control unit for adjusting the inflation of each said plurality of sub-unit bladders and a heater unit for adjusting the temperature of water supplied to each said plurality of sub-unit bladders.

In another embodiment the apparatus comprising a unitary torso-abdominal support cushion having a recess configured for accommodating human breasts and accommodating a mid-section of an obese person or pregnant woman, wherein the recess is configured to provide an adjustable support structure adaptive to the size of the human breasts and/or the mid-section of an obese person or pregnant woman.

In another aspect the recess further comprises a mesh material coupled to the backing of the unitary torso-abdominal support cushion for providing the adjustable support structure adaptive to the size of the human breasts and/or the mid-section of an obese person or pregnant woman.

In yet another aspect the recess further comprises a plurality of donut shaped bladders coupled to the backing of the unitary torso-abdominal support cushion for providing the adjustable support structure adaptive to the size of the human breasts and/or the mid-section of an obese person or pregnant woman.

### BRIEF DESCRIPTION OF THE DRAWINGS

The following discussion of the exemplary embodiments of this invention is made more evident in the following Detailed Description, when read in conjunction with the attached Drawing Figures, wherein:

FIG. 1(a) is an illustration of a therapeutic treatment table in accordance with exemplary embodiments of the invention;

FIG. 1(b) is an illustration of a therapeutic treatment table in accordance with another exemplary embodiment of the invention;

FIG. 1(c) is an illustration of a therapeutic treatment table including an alternative support frame in accordance with exemplary embodiments of the invention;

FIG. 1(d) is an illustration of a therapeutic treatment table including a unitary upper torso support cushion, and abdominal support cushion, in accordance with exemplary embodiments of the invention;

FIG. 2(a) is an illustration of a top view of an upper torso support cushion unit showing a left and a right breast insert cushions inserted in the upper torso support cushion unit in accordance with exemplary embodiments of the present invention;

FIG. 2(b) is an illustration of top view of an upper torso support cushion unit revealing the left and right mesh material in accordance with exemplary embodiments of the present invention;

FIG. 2(c) is an illustration of a side view of an upper torso support cushion unit in accordance with exemplary embodiments of the present invention;

FIG. 3(a) is an illustration of a top view of an upper torso support cushion unit showing a left and a right breast insert cushions inserted in the upper torso support cushion unit in accordance with another exemplary embodiment of the present invention;

FIG. 3(b) is an illustration of top view of an upper torso support cushion unit revealing the left and right donut shaped bladder units in accordance with exemplary embodiments of the present invention;

FIG. 3(c) is an illustration of a side view of an upper torso support cushion unit in accordance with exemplary embodiments of the present invention;

FIG. 4(a) is an illustration of a top view of an abdominal support cushion unit showing an abdominal insert cushion inserted in the abdominal support cushion unit in accordance with exemplary embodiments of the present invention;

FIG. 4(b) is an illustration of a top view of an abdominal support cushion unit disclosing an abdominal mesh material in accordance with exemplary embodiments of the present invention;

FIG. 4(c) is an illustration of a side view of an abdominal support cushion unit in accordance with exemplary embodiments of the present invention;

FIG. 5(a) is an illustration of a top view of an abdominal support cushion unit showing an abdominal insert cushion inserted in the abdominal support cushion unit in accordance with another exemplary embodiment of the present invention;

FIG. 5(b) is an illustration of a top view of an abdominal support cushion unit showing an abdominal insert cushion inserted in the abdominal support cushion unit in accordance with another exemplary embodiment of the present invention;

FIG. 5(c) is an illustration of a side view of an abdominal support cushion unit in accordance with exemplary embodiments of the present invention;

FIG. 6(a) is an illustration of a top view of upper torso support cushion unit showing a single breast insert cushion inserted in the upper torso support cushion unit in accordance with additional exemplary embodiment of the present invention;

FIG. 6(a-1) is an illustration of a top view of upper torso support cushion unit disclosing an abdominal mesh material in accordance with exemplary embodiments of the present invention;

FIG. 6(a-2) is an illustration of a top view of upper torso support cushion unit disclosing a single multi-donut shaped bladder unit in accordance with additional exemplary embodiment of the present invention;

FIG. 6(b) is an illustration of a top view of an abdominal support cushion unit showing an unitary-torso-abdominal insert cushion inserted in the abdominal support cushion unit in accordance with additional exemplary embodiment of the present invention;

FIG. 6(b-1) is an illustration of a top view of an abdominal support cushion unit disclosing an abdominal mesh material in accordance with exemplary embodiments of the present invention;

FIG. 6(b-2) is an illustration of a top view of an abdominal support cushion unit disclosing a multi-donut shaped bladder unit in accordance with yet another exemplary embodiment of the present invention;

FIG. 7 is an illustration an upper torso support cushion unit including a donut shaped baffle unit and a control mechanism in accordance with exemplary embodiments of the invention;

FIG. 8 is an illustration an abdominal support cushion unit, including a donut shaped baffle unit and a control mechanism in accordance with exemplary embodiments of the invention;

FIG. 9 depicts a controller unit configured for carrying out the method and computer operations of inflating the baffles of the various exemplary embodiments of the invention.

### DETAILED DESCRIPTION

The exemplary embodiments of this invention provide a therapeutic or treatment bed, bench or table for pregnant, obese and/or special needs patients or patrons.

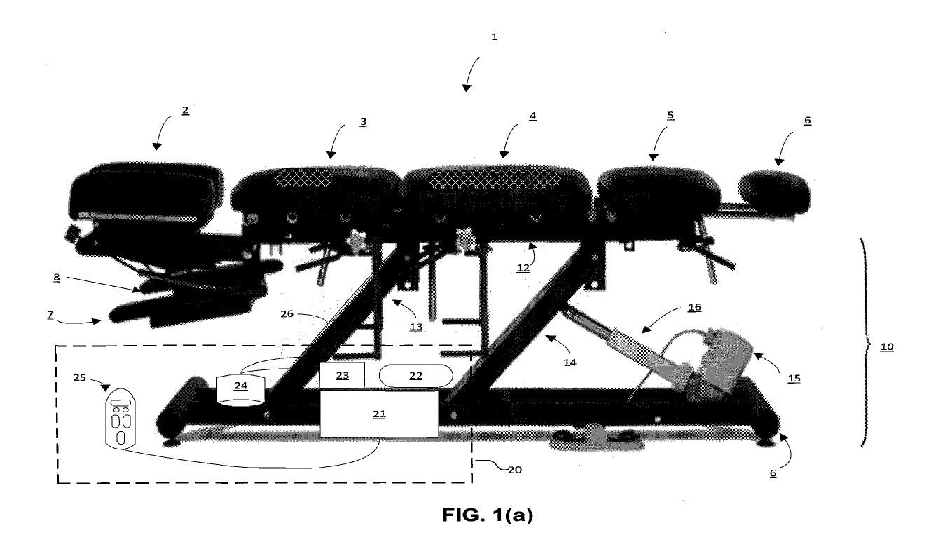

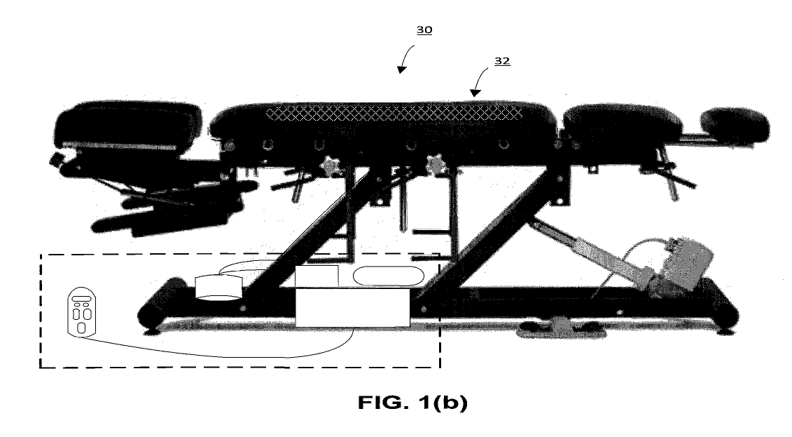

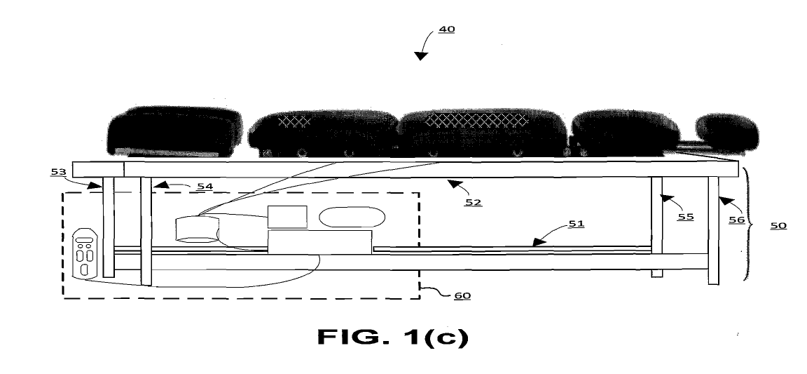

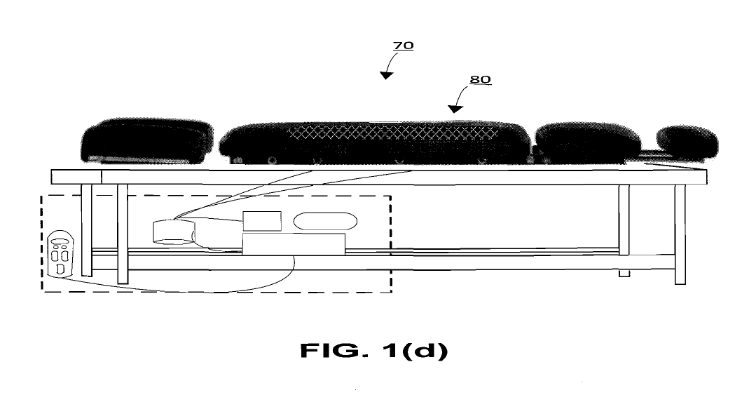

Referring to FIG. 1(a) a therapeutic treatment bed, bench, or table [“treatment table”] 1 is shown in accordance with exemplary embodiments of the invention. The treatment table 1 includes several support cushions allowing a patron to receive treatment from a chiropractor, masseur a variety of medical professionals, or sports trainers. As shown in FIG. 1(a), a face support cushion 2, an upper torso support cushion 3, an abdominal support cushion 4, a hip/thigh support cushion 5, and a calf/bolster support cushion 6, provide a planar support surface for the patron. It is desirable that each cushion is constructed of such non-limiting materials as foam or inner springs covered with a durable polyvinyl, plastic, leather or canvas surface. In addition, each cushion includes hardened solid backing which allows each cushion to be coupled to a support frame. The hardened solid backing can be made of such non-limiting materials as wood, laminate, plastic, fiberglass, aluminum or steel. In FIG. 1(a), the support frame 10 includes a lower base frame 6 and upper frame 12. A first (left) support arm 7, and second (right) support arm 8, are hinged to the upper frame 12, directly below the face support cushion 2, and upper torso support cushion 3. An electric motor 15, and pneumonic pump 16, are coupled to the second support arm 14, for lowering/raising the treatment table 1 (together with the first support arm 13), as well as tilting the table.

FIG. 1(a) also shows an optional control mechanism 20, which includes a controller unit 21, a pump 22, a regulator 23, as well as an optional heater 24. A remote control 25 is provided for carrying out one or more methods of inflating baffles by means of air, or heated or cooled water, by means of a plurality of tubing 26 in accordance with exemplary embodiments of the present invention as described below.

Referring now to FIG. 1(b), a therapeutic treatment bed or table 30 is shown in accordance with another exemplary embodiment of the invention. As shown in FIG. 1(b), the table includes a unitary upper torso support cushion and abdominal support cushion 32.

Referring now to FIGS. 1(c) and 1(d), an alternative support frame and an embodiment including a unitary upper torso support cushion, as well as an abdominal support cushion, is illustrated according to exemplary embodiments of the invention. As shown in FIG. 1(c), a traditional treatment table frame 50 is shown including four vertical legs 52/54/55/56, an upper frame 52, and a lower shelf support 51. The frame 50 can be constructed of such non-limiting materials as wood, laminate, plastic, fiberglass, aluminum or steel. Various additional modular components can be added, such as shelves, cabinet doors and drawers (not shown), such as those known in the art. The traditional treatment table frame 50 can be configured to include an optional control mechanism 60 as described above with respect to the first embodiment.

FIG. 1(d) illustrates the therapeutic treatment table 70 shown in FIG. 1(c), including a unitary upper torso support cushion and abdominal support cushion 80. The support frames shown in FIGS. 1(a)-1(d) are non-limiting examples of support frames known in the art, which are capable of supporting the present invention's cushions and control unit.

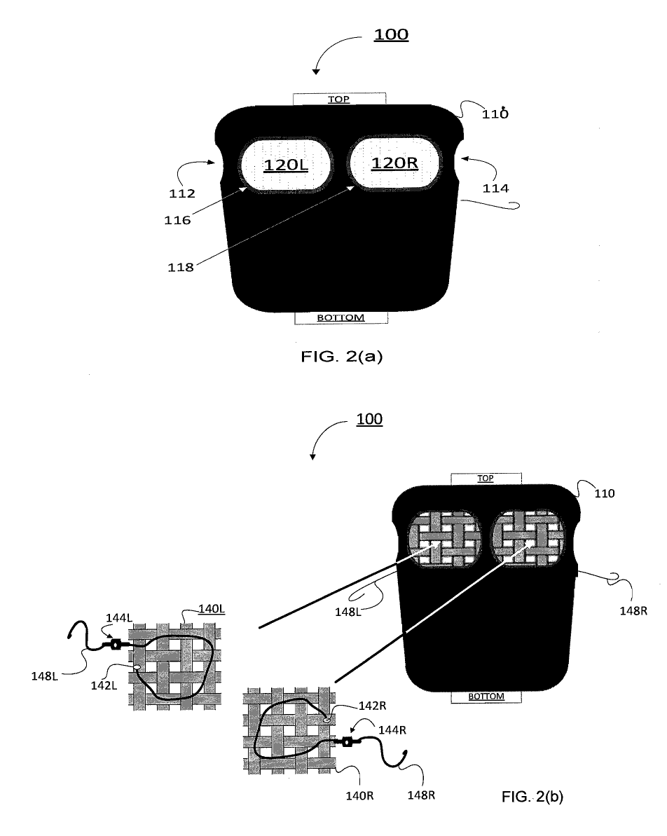

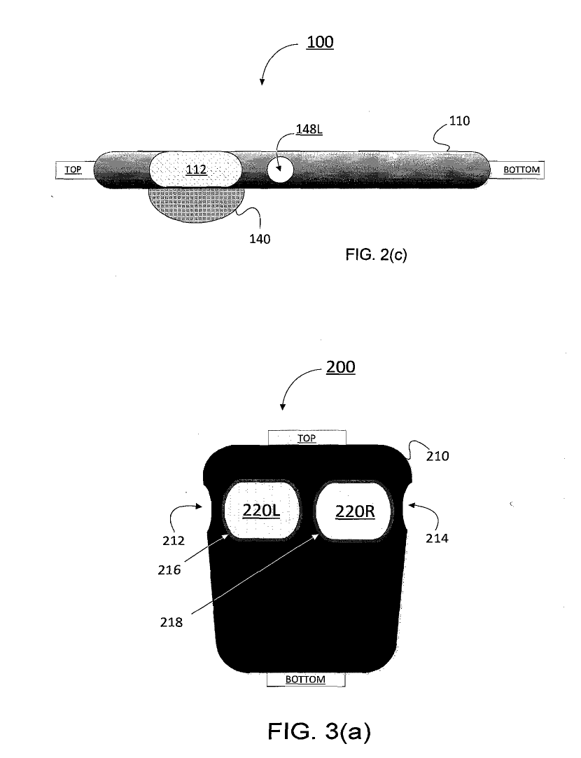

Referring now to FIG. 2(a)-(c), an illustration of an upper torso support cushion unit 100 is shown in accordance with exemplary embodiments of the present invention. The upper torso support cushion 110 is constructed of such non-limiting materials as foam or inner springs covered with a durable polyvinyl, plastic, leather or canvas surface. A left arm indentation 112, and right arm indentation 114, are provided for receiving a patron's arms. Upper torso support cushion 110 includes a left breast receiving opening 116, and right breast receiving opening 118. A left breast insert cushion 120L, and right breast insert cushion 120R, are adapted for insertion in the upper torso support cushion 110 when not needed (i.e., when the patron has no breasts or small breasts). A left mesh material 140L is coupled to the backing of the upper torso support cushion 110, and also coupled to the left breast receiving opening 116. Likewise, the right mesh material 140R is coupled to the backing of the upper torso support cushion 110, and also coupled to the right breast receiving opening 118. The mesh material is constructed of an elastic material with bands of material stitched and interwoven in each row. Under pressure and tension, the material creates a deformation suitable for receiving a breast as shown in the side view of the upper torso support cushion 110.

A left tension string 148L is interlaced in left mesh material 140L with a left anchor fastener 142 securing the string to the mesh material. An alternative embodiment can provide that the left anchor fastener 142L is secured to the backing of the upper torso support cushion 110. A left push button string clamp 144L is coupled to the left tension string 148L. Likewise, a right tension string 148R is interlaced in right mesh material 140R with a right anchor fastener 142R securing the string to the mesh material. An alternative embodiment can provide that the right anchor fastener 142R is secured to the backing of the upper torso support cushion 110. A right push button string clamp 144R is coupled to the left tension string 148R.

In operation, a patron, chiropractor or masseuse can control the tension of the mesh material, thereby adjusting the size of the opening from the fully expanded to fully restricted position and any position in between those two extremes (i.e. customize the size of the left and/or right breast receiving openings).

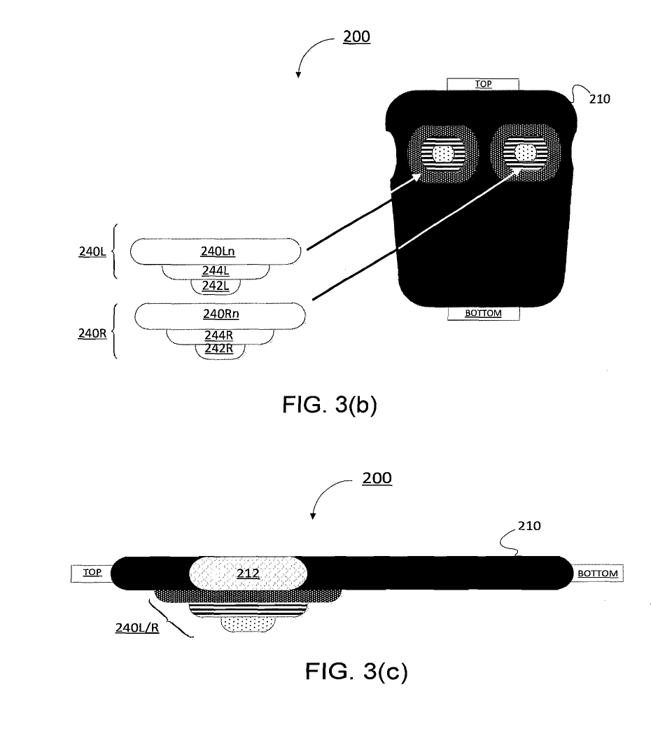

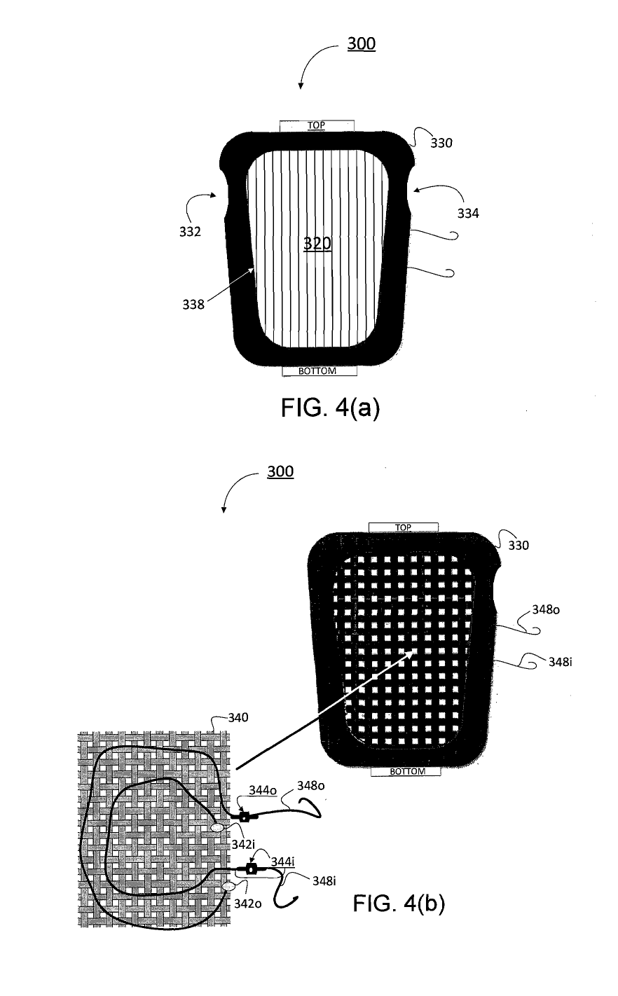

Referring now to FIG. 3(a)-(c) an illustration of an upper torso support cushion unit 200 is shown in accordance with another exemplary embodiment of the present invention.

The upper torso support cushion 210 is constructed of such non-limiting materials as foam or inner springs covered with a durable polyvinyl, plastic, leather or canvas surface. A left arm indentation 212, and right arm indentation 214, are provided for receiving a patron's arms. The Upper torso support cushion 210 includes a left breast receiving opening 216 and right breast receiving opening 218. A left breast insert cushion 220L, and right breast insert cushion 220R, are adapted for insertion in the upper torso support cushion 210 when not needed (i.e., when the patron has no breasts or small breasts).

A left donut shaped bladder unit 240L is provided and coupled to the backing of the upper torso support cushion 210 and to the left breast receiving opening 216. As shown in FIG. 3, the left donut shaped bladder unit 240L includes at least three separate bladder sub-units attached to hosing or tubes to allow inflation of the units with either air or water (heated or cooled). In operation, depending on the size of the breast, the first sub-unit 242L, second sub-unit 244L, and third sub-unit 246L may be inflated with air, or heated or cooled water, to provide support for the left breast.

A right donut shaped bladder unit 240R is provided and coupled to the backing of the upper torso support cushion 210 and to the right breast receiving opening 218. As shown in FIG. 3, the left donut shaped bladder unit 240R includes at least three separate sub-unit bladders attached to hosing or tubes to allow inflation of the units with either air or water (heated or cooled). In operation, depending on the size of the breast, the first sub-unit bladder 242R, second sub-unit bladder 244R, and third sub-unit bladder 246R may be inflated with air, or heated or cooled water, to provide support for the right breast.

The number of sub-units in the left and right donut shaped bladder units, 240L/240R, can be a number greater than three. In addition, the material used to make those bladder units can be rubber or any material suitable for retaining air or water.

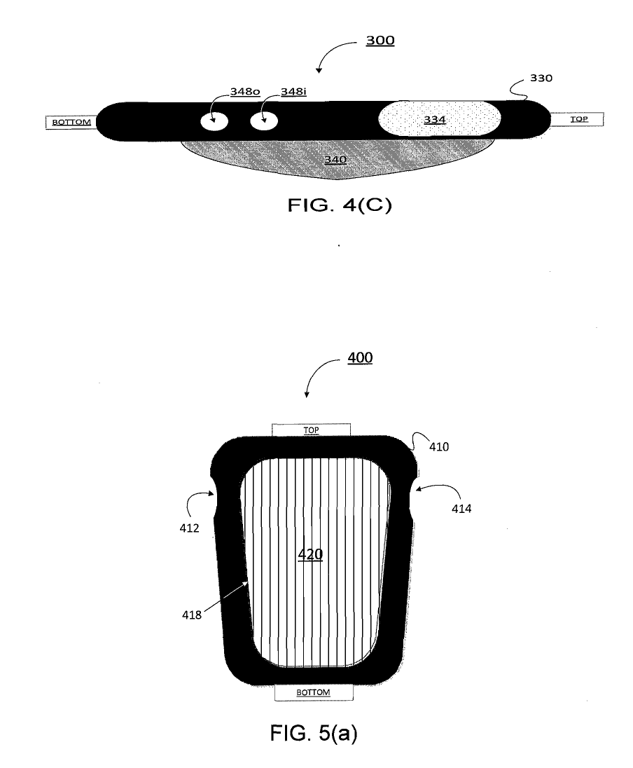

Referring now to FIG. 4(a)-(c), an abdominal support cushion unit 300 is shown in accordance with exemplary embodiments of the present invention. The abdominal support cushion 330 is constructed of such non-limiting materials as foam or inner springs covered with a durable polyvinyl, plastic, leather or canvas surface. An optional left arm indentation 332, and right arm indentation 334, are provided for receiving a patron's arms. The abdominal support cushion 330 includes an abdominal receiving opening 338. An abdominal insert cushion 320 is adapted for insertion in the abdominal support cushion 310 when extra space is not needed i.e. when the patron does not have a large belly or is pregnant). Accordingly, when the abdominal insert cushion 320 is inserted in the abdominal support cushion 310, the table is configured as a traditional treatment or therapeutic table. An abdominal mesh material 340 is coupled to the backing of the abdominal support cushion 330 and to the abdominal receiving opening 338. The abdominal mesh material 340 is constructed of an elastic material with bands of material stitched and interwoven in each row. Under pressure and tension, the material creates a deformation suitable for receiving a large abdomen or pregnant woman's extended abdomen as shown in the side view of the abdominal support cushion 330.

An outer abdominal tension string 348o is interlaced in the abdominal mesh material 340, with an outer anchor fastener 342o securing the string to the mesh material. An alternative embodiment can provide that the outer anchor fastener 342o is secured to the backing of the abdominal support cushion 330. An outer push button string clamp 344o is coupled to the outer abdominal tension string 344o. Likewise, an inner abdominal tension string 348i is interlaced in the mesh material 340 with an inner anchor fastener 342i securing the string to the mesh material. An alternative embodiment can provide that the inner anchor fastener 342i is secured to the backing of the abdominal support cushion 330. An inner push button string clamp 344i is coupled to the inner abdominal tension string 348i.

In operation a patron, chiropractor, masseuse, or other treatment professional, can control the tension of the mesh material, thereby adjusting the size of the opening from the fully expanded to fully restricted position and any position in between those two extremes (i.e. customize the size of the abdominal receiving opening).

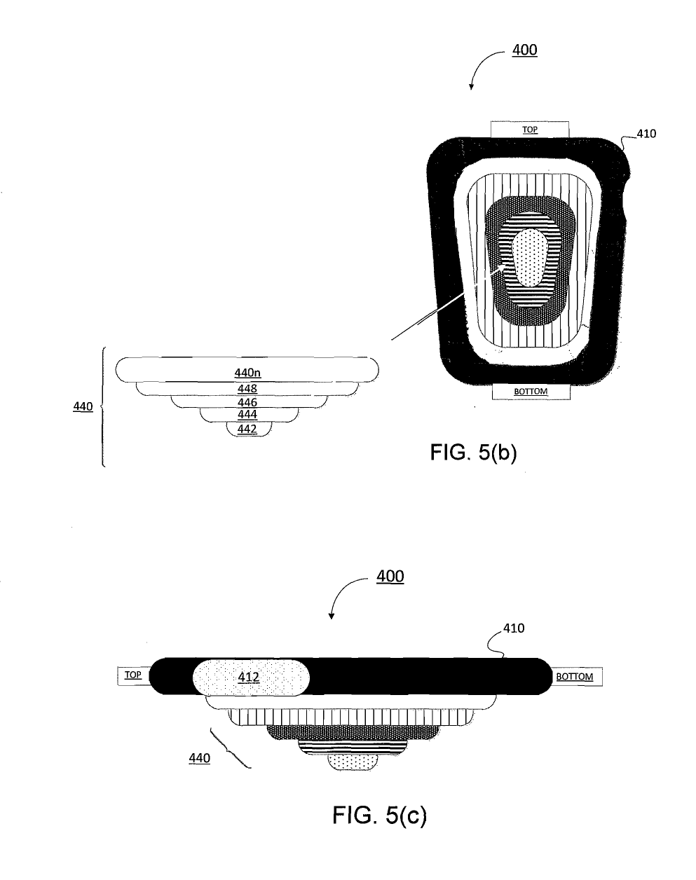

Referring now to FIG. 5(a)-(c), an abdominal support cushion unit 400 is shown in accordance with another exemplary embodiment of the present invention. The abdominal support cushion 410 is constructed of such non-limiting materials as foam or inner springs covered with a durable polyvinyl, plastic, leather or canvas surface. An optional left arm indentation 412, and right arm indentation 414, are provided for receiving patron's arms. The abdominal support cushion 400 includes an abdominal receiving opening 418. An abdominal insert cushion 420 is adapted for insertion in the abdominal support cushion 410 when not needed (i.e., when the patron does not have a large abdomen or is not pregnant).

An abdominal shaped bladder unit 440 is provided and coupled to the backing of the abdominal support cushion 410, and to the abdominal receiving opening 418. As shown in FIG. 5, the abdominal shaped bladder unit 440 is a donut shaped bladder unit, including at least five separate inflatable sub-unit bladders attached to hosing or tubes (not shown) to allow inflation of each separate bladder with either air or water (heated or cooled). In operation, depending on the size of the belly, the first donut shaped bladder 442, second donut shaped bladder 444, third donut shaped bladder 446, fourth donut shaped bladder 448 and fifth donut shaped bladder 440n may be inflated with air, or with heated or cooled water, to provide support for the patient's or patron's abdomen or mid-section.

The number of sub-unit bladders in the abdominal shaped bladder unit 440 can be a number greater than five. In addition, the material used to make the bladder and its subunits can be rubber or any material suitable for retaining air or water.

The size of the breast receiving opening of the upper torso support cushion or abdominal receiving opening of the abdominal support cushion can be enlarged in accordance with additional alternative exemplary embodiments of the invention.

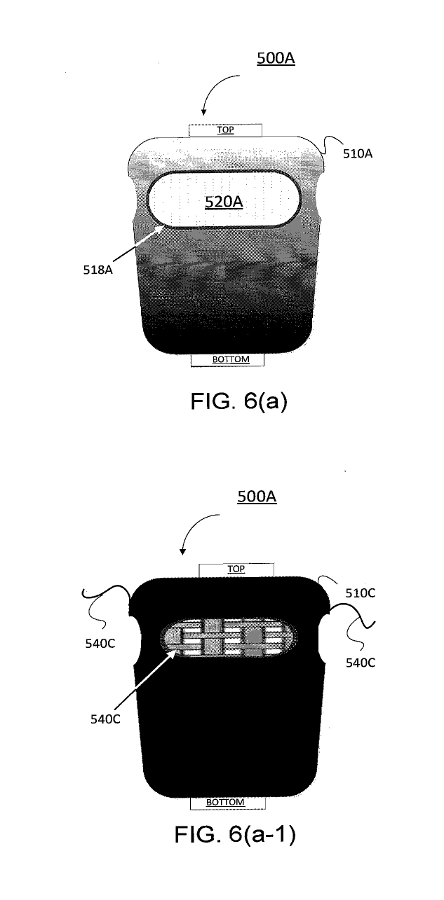

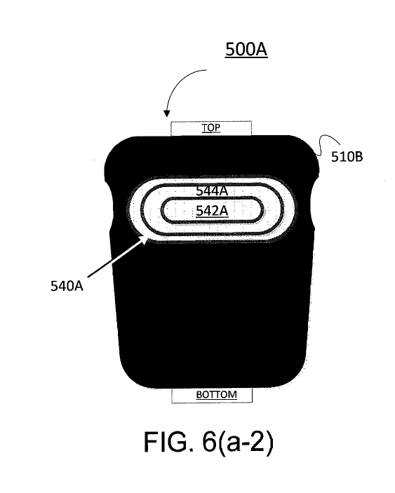

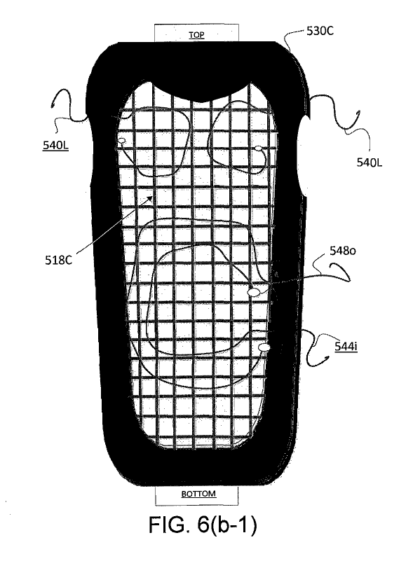

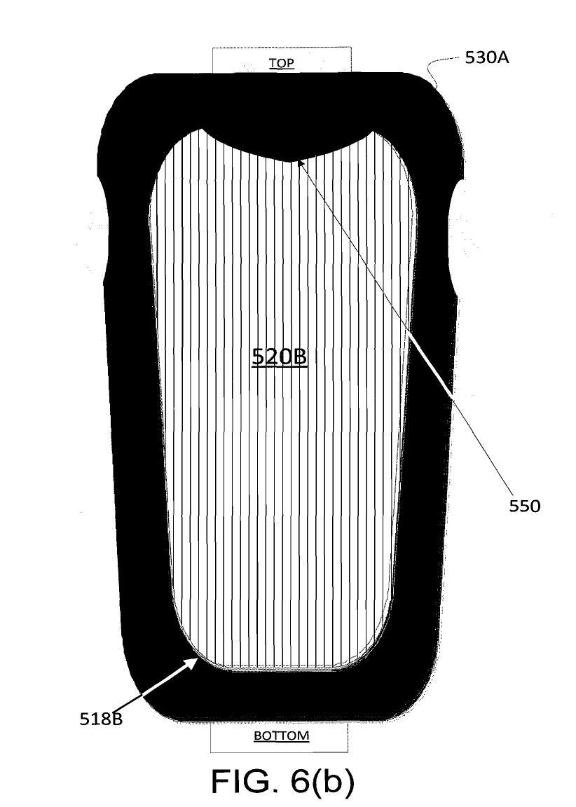

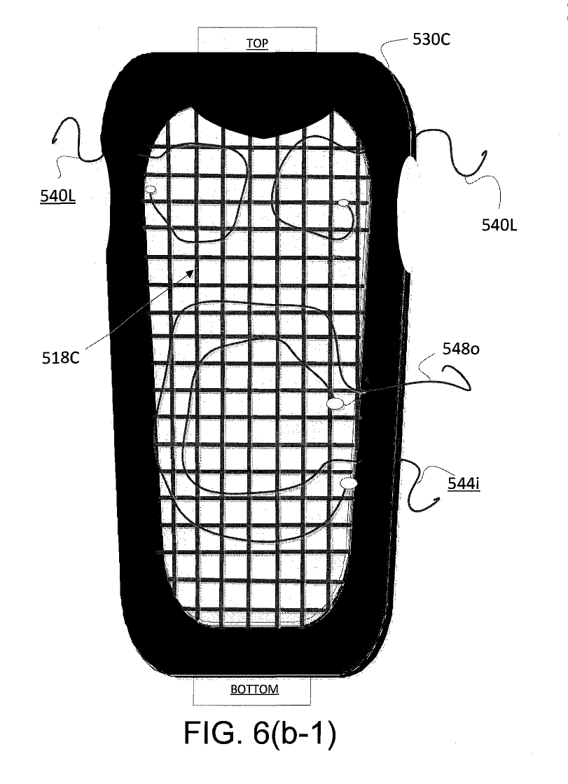

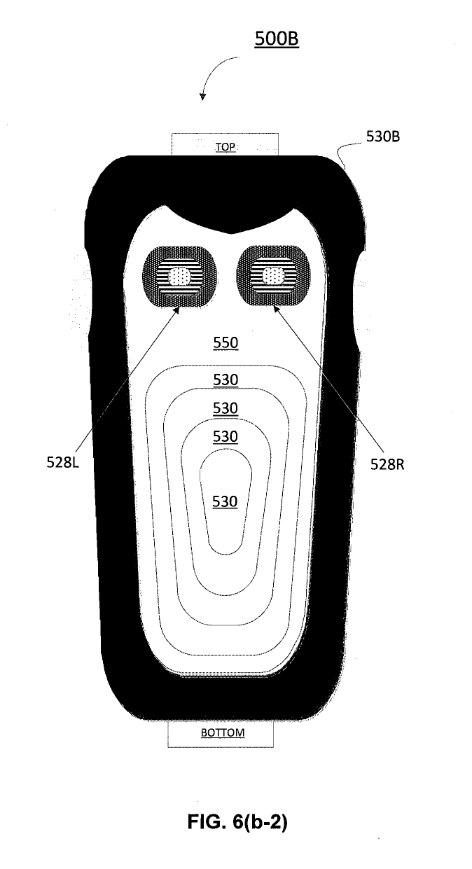

For example, as illustrated in FIG. 6(a), an upper torso support cushion unit 500A can be configured to include a single breast receiving opening 518A in the upper torso support cushion 510A. A single breast insert cushion 520A is adapted for insertion in the upper torso support cushion 510A when not needed (i.e., when the patron has no breasts or small breasts). In one further embodiment as shown in FIG. 6(b-1), the upper torso support cushion unit 500A includes an upper torso support cushion 510C, comprising mesh material 540C, tension strings 542C as well as an anchor fastener and a push button string clamp (not shown). In yet another further embodiment as shown in FIG. 6(b-2), the upper torso support cushion unit 500A includes a upper torso support cushion 510B, comprising a single multi-donut shaped bladder unit 540A which includes an inner donut shaped baffle 542A and outer donut shaped baffle 544A. The number of bladders in the single multi-donut shaped bladder unit 540A can be a number greater than two. In addition, the material used to make the bladder and its subunits can be rubber or any material suitable for retaining air or water.

FIG. 6(b) g(b-1) and 6(b-2) illustrates unitary torso-abdominal support cushion units 500B/500C which include an enlarged abdominal receiving opening in an abdominal support cushion in accordance with further exemplary embodiments of the invention. In particular, the abdominal support cushion units are elongated to replace the upper torso support cushion and abdominal support cushion as shown in FIGS. 1(b) and 1(d). The unitary torso-abdominal support cushion 530A is constructed of such non-limiting materials as foam or inner springs covered with a durable polyvinyl, plastic, leather or canvas surface. The unitary torso-abdominal support cushion includes a breast receiving opening and an abdominal receiving opening 518B. The unitary torso-abdominal insert cushion 530A is adapted for insertion in the unitary torso-abdominal support cushion 530A when not needed (i.e. when the patron has no breasts or small breasts or does not have a large belly or is not pregnant). Accordingly, when the unitary-torso-abdominal insert cushion 520A is inserted in the unitary torso-abdominal support cushion, the table is configured as a traditional treatment or therapeutic table.

In one further embodiment, the unitary torso-abdominal support cushion unit 500B includes a unitary torso-abdominal support cushion 530C comprising a single mesh material 518C, a left and right breast tension string 540L/540L, an inner and outer abdominal tension string 548i/540o, as well as an anchor fastener and push button string clamp (not shown). In yet another further embodiment, the unitary torso-abdominal support cushion unit 500C includes a unitary torso-abdominal support cushion 530B comprising a single multi-donut shaped bladder unit 540 which includes a left and right donut shaped baffle 528L/528R and an abdominal donut shaped baffle unit 530. The abdominal donut shaped baffle unit 530 can include several individual sub-unit baffles including a first sub-unit baffle 532, a second sub-unit baffle 534, a third sub-unit baffle 536 and a fourth sub-unit baffle 538. The number of sub-unit bladders in the single donut shaped bladder unit 540 can be a number greater than four. In addition, the material used to make the bladder and its subunits can be rubber or any material suitable for retaining air or water. An outer membrane unit 550 is configured for housing the left and right donut shaped baffles 528L/528R and abdominal donut shaped baffle unit 530. In another further embodiment, the outer membrane 550 can be inflated to provide further support. In an alternative embodiment, the outer membrane is a solid foam filled cushion which provides a firm planar support surface between the three baffle sections (i.e., the left and right breast donut shaped baffles and the abdominal donut shaped baffle).

The apparatuses, methods and computer program operations for inflating the baffles of the various exemplary embodiments of the invention is described below with reference to FIGS. 7-9.

As shown in FIG. 7, an upper torso support cushion unit 600 is shown comprising a donut shaped baffle unit 640 in accordance with exemplary embodiments of the invention. For simplicity, only the left side view of the upper torso support cushion 610 is shown. As shown in FIG. 7, the upper torso support cushion 610 includes a left donut shaped bladder unit 640L. That baffle unit includes at least three donut shaped baffles capable of being inflated by air or hot/cold water. In particular, the left multi-donut shaped bladder unit 640L includes a first left donut shaped baffle 642L, a second left donut shaped baffle 644L, and a third left donut shaped baffle 640Ln. Further embodiments of the invention can include additional donut shaped baffles.

FIG. 7 also shows an inflation control mechanism 600A, which includes a controller unit 660, a pump 670, a regulator 680, as well as an optional heater 690. A remote control (not shown) can be provided for carrying out one or more methods of inflating baffles by means of air or heated or cooled water by means of a plurality of tubing a, b and n in accordance with exemplary embodiments of the present invention as described below.

Referring now to FIG. 8, an abdominal support cushion unit 700 is shown comprising an abdominal multi-donut shaped baffle unit 740 in accordance with exemplary embodiments of the invention. As shown in FIG. 8, the abdominal support cushion 730 includes an abdominal donut shaped bladder unit 740 capable of being inflated by air or hot/cold water. In particular, that abdominal donut shaped bladder unit 740 includes a first donut shaped baffle 742, a second left donut shaped baffle 744, a third left donut shaped baffle 746, a fourth donut shaped baffle 748, and a fifth donut shaped baffle 740n. Further embodiments of the invention can include additional donut shaped baffles.

FIG. 8 also shows an inflation control mechanism 700A, which includes a controller unit 760, pump 770, a regulator 780 as well as an optional heater 790. A remote control (not shown) can be provided for carrying out one or more methods of inflating baffles by means of air or heated or cooled water by means of a plurality of tubing aa, bb, cc, dd, and nn in accordance with exemplary embodiments of the present invention as described below.

Another embodiment of the invention provides a single inflation control mechanism for inflating the baffle units 640/740 shown in FIGS. 7 and 8. In such an embodiment, the single inflation control mechanism supplies air, or heated or cooled water, by means of a single regulator which feeds the plurality of tubing a, b, and n as well as tubing aa, bb, cc, dd, and nn in accordance with exemplary embodiments of the present invention.

Referring now to FIG. 9, a controller unit 860 is shown which is configured for carrying out the method and computer operations of inflating the baffles of the various exemplary embodiments of the invention is described below with reference to FIGS. 7-8. The controller unit 860 includes a controller 862, a memory and a computer program 866 with operational steps capable of controlling the amount of air, or hot or cold water, added to or placed within or pumped into in the donut shaped baffles in FIGS. 7 and 8. The processor 862 can be a microprocessor, microcontroller, field programmable gate array, or digital signal processor. The controller unit 860 can optionally include a UART chip 868A for allowing a remote control to be physically coupled to the control unit 860 via wired connection to the unit. Alternatively, the controller unit 860 can include an RF unit 868B for allowing wireless communications between the unit and a remote control.

Various exemplary embodiments of the invention described above provide a novel therapeutic or treatment table which allows for support for a woman's breasts and/or an abdominal or mid-section. As known in the art, when downward force is applied to one or more vertebrae of the human body, it is necessary that the downward force not be resisted by muscular action during treatment. Accordingly, the exemplary embodiments of the invention provide support such that the patron or patient does not tense up or contract his or her muscles upon receiving a massage or chiropractic treatment from behind the breasts or mid-section or abdomen.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein, two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and/or the optical region (both visible and invisible), as several non-limiting and non-exhaustive examples.

The foregoing description has provided by way of exemplary and non-limiting examples a full and informative description of the invention. However, various modifications and adaptations may become apparent to those skilled in the relevant arts in view of the foregoing description, when read in conjunction with the accompanying drawings. Furthermore, all such and similar modifications of the teachings of this invention will still fall within the scope of the non-limiting and exemplary embodiments of this invention.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1. An apparatus, comprising:
an upper torso support cushion having a plurality of breast recesses configured for accommodating human breasts,
an abdominal support cushion having a abdominal recess configured for accommodating a mid-section of an obese person or pregnant woman,
wherein the plurality of recesses are configured to provide an adjustable support structure adaptive to the size of the human breasts, or the mid-section of an obese person or pregnant woman.

2. The apparatus of claim 1, wherein the plurality of breast recesses further comprise:
a left and right mesh material coupled to the backing of the upper torso support cushion for providing the adjustable support structure adaptive to the size of the human breasts.

3. The apparatus of claim 2, wherein the left and right mesh material are elastic material configured with bands of material stitched and interwoven in rows.

4. The apparatus of claim 3, further comprising:
a left and right tension string circularly interlaced in the left and right mesh material and anchored to the backing of the upper torso support cushion.

5. The apparatus of claim 4, further comprising:
a left and right push button string clamp configured for attaching to the left and right tension strings adaptable for constricting the left and right mesh material in a convex shape.

6. The apparatus of claim 1, wherein the plurality of recesses further comprise:
a left and right donut shaped bladder unit coupled to the backing of the upper torso support cushion for providing the adjustable support structure adaptive to the size of the human breasts.

7. The apparatus of claim 6, wherein the left and right donut shaped bladder unit further comprise:
a plurality of sub-unit bladders configured for inflation by air, or hot or cold water, for providing the adjustable support structure adaptive to the size of the human breasts.

8. The apparatus of claim 1, wherein the abdominal recess further comprises:
an abdominal mesh material coupled to the backing of the abdominal support cushion for providing the adjustable support structure adaptive to the mid-section of an obese person or pregnant woman.

9. The apparatus of claim 8, wherein the abdominal mesh material is an elastic material configured with bands of material stitched and interwoven in rows.

10. The apparatus of claim 9, further comprising:
a plurality of tension strings, each circularly interlaced in the abdominal mesh material and anchored to the backing of the abdominal support cushion,
wherein each tension string is interlaced in the abdominal mesh to create successive rings to form a convex shape.

11. The apparatus of claim 10, further comprising:
a plurality of push button string clamps configured for attaching to a plurality of tension strings adaptable for constricting the abdominal mesh material in a convex shape.

12. The apparatus of claim 1, wherein the abdominal recess further comprises:
a plurality of donut shaped bladders coupled to the backing of the abdominal support cushion for providing the adjustable support structure adaptive to the mid-section of an obese person or pregnant woman.

13. The apparatus of claim 12, wherein the plurality of donut shaped bladder units further comprise:
a plurality of sub-unit bladders configured for inflation by air, or hot or cold water, for providing the adjustable support structure adaptive to the mid-section of an obese person or pregnant woman.

14. The apparatus of claim 7, further comprising:
an inflation control mechanism including a controller unit, pump, and regulator for inflating the plurality of sub-unit bladders by means of one or more tubes coupled to each said sub-unit baffle.

15. The apparatus of claim 14, further comprising:
a remote control unit for adjusting the inflation of each said plurality of sub-unit bladders; and
a heater unit for adjusting the temperature of water supplied to each said plurality of sub-unit bladders.

16. The apparatus of claim 13, further comprising:
an inflation control mechanism includes a controller unit, pump, and regulator for inflating the plurality of sub-unit bladders by means of one or more tubes coupled to each said sub-unit baffle.

17. The apparatus of claim 16, further comprising:
a remote control unit for adjusting the inflation of each said plurality of sub-unit bladders; and
a heater unit for adjusting the temperature of water supplied to each said plurality of sub-unit bladders.

18. An apparatus, comprising:
a unitary torso-abdominal support cushion having a recess configured for accommodating human breasts and accommodating a mid-section of an obese person or pregnant woman,
wherein the recess is configured to provide an adjustable support structure adaptive to the size of the human breasts and/or the mid-section of an obese person or pregnant woman.

19. The apparatus of claim 18, wherein the recess further comprises:
a mesh material coupled to the backing of the unitary torso-abdominal support cushion for providing the adjustable support structure adaptive to the size of the human breasts and/or the mid-section of an obese person or pregnant woman.

20. The apparatus of claim 18, wherein the recess further comprises:
a plurality of donut shaped bladders coupled to the backing of the unitary torso-abdominal support cushion for providing the adjustable support structure adaptive to the size of the human breasts and/or the mid-section of an obese person or pregnant woman.
